(19) United States
(12) Patent Application Publication
(10) Pub. No.: US 2007/0140555 A1
(43) Pub. Date: Jun. 21, 2007

(54) Facial image processing system

(76) Inventor: Takeyoshi Iguchi, Tokyo (JP)

Correspondence Address: Cameron Kerrigan;Squire Sanders & Dempsey, Suite 300, One Maritime Plaza, San Francisco, CA, 94111-3492, US

(21) Appl. No.: 10/588,942

(22) PCT Filed: Jan. 31, 2005
(86) PCT No.: PCT/JP05/01351

§ 371 Date: Aug. 7, 2006

(30) Foreign Application Priority Data
Feb. 12, 2004 (JP) 2004-034769

(51) Int. Cl. G06K 9/00

(52) U.S. Cl. 382/167

(57) ABSTRACT

A facial image processing system for conducting an image process onto a photographed facial image, including a changing means which is at least one of a facial expression changing means to change the expression of a photographed facial image, a skin color tone changing means to change the color tone of facial skin of the photographed facial image, an illumination changing means to artificially change a lighting condition of the photographed facial image, and a photo angle changing means to artificially change the photo angle of the photographed facial image, an image processing means, an image display means, and an operation means, wherein at least one of the changing means is selected by the operation means, and the plural changed facial images, obtained via conducting the image processing on the photographed facial image, are displayed on the image display means in the order from a small changed facial image to a large changed facial image.

### TECHNICAL FIELD

The present invention relates to a facial image processing system, in which image processing operation is conducted onto the photographed facial image, and plural facial images formed by the image processing operation are displayed in a line, after which an optimal facial image is selected from among them.

### BACKGROUND ART

Generally, the large factor for judging good or bad portrait photography are facial expression, facial color tone, light and shade, and photographic angle. Among them, the most dominating factor is facial expression. However facial expression always changes, whereby it is very difficult for a photographer to take an optimal shutter chance. Further, the cases are common in that a person to be photographed cannot show the desired facial expression due to tension or other reasons.

In cases of conventional analog photography, such problems have been overcome by the photographer personality in guiding the subject, as well as technology of getting a precise and instantaneous shutter chance. If the photographed image includes any disadvantages, and if re-photography is impossible, retouching work is conducted on photographed prints. That is, an experienced person alters the image by hand paint. However, even the person of experience can amend the closed eyes or the facial winkles, facial expression cannot be.

However, due to the remarkable progress of digital image processing technology, image processing by digital technology can be conducted on photographed facial images (hereinafter referred to as “original image”), and more recently, progressed technologies are-able to create a completely new facial image, produced from the original image. Such service is now commonly provided on the field (see Patent Document 1), and further, changed skin tone can be also provided which is more easily conducted than altering facial expression (see Patent Document 2), or altering light and shade (see Patent Document 3), and altering photographic angle (see Patent Document 4).

Among the process conducted on an image for alteration of each factor, the generation of a new facial expression by the digital image re-processing can be used not only for enjoying various facial images or evaluating a new facial image, but also for allowing the person to copy the facial expression produced by digital image processing. Further, even those who rarely smile, or those whose facial muscles do not work well, and therefore cannot make a happy expression, the above digital generation of a new facial expression can be used to suggest the possibility of making new facial expression.

The digitally processed facial images, which are obtained via digital image processing conducted on an original image for a particular purpose, are shown on an image displaying means, or in other case, the original image as well as the processed image are lined up and displayed simultaneously, and are used for checking images to obtain a targeted image. However, it is not easy to obtain the targeted facial image, and in most cases, greatly necessary is the repeated trial and error operation of changing the facial image on the display.

In order to decrease the trial and error process, plural facial images obtained via image processing are listed and displayed on the displaying means, and the user can select the optimal facial image from among them. Via this method, in many cases, the user can simultaneously compare plural facial images and can easily choose the optimal facial image. The above cases assumes that there is only one factor changed, and a change of a particular section of the facial image is easily noticed, for example, a change of lip color, or a change in hair style.

However, when the very slightly changed facial images are displayed, or when plural facial images are changed in two or more factors, in most cases, it is difficult to select the best facial image from among the displayed facial images.
[Patent Document 1] Unexamined Japanese Patent Application Publication No. 11-167626
[Patent Document 2] Unexamined Japanese Patent Application Publication No. 2000-151985
[Patent Document 3] Unexamined Japanese Patent Application Publication No. 7-46577 (pages 2-3)
[Patent Document 4] Unexamined Japanese Patent Application Publication No. 2000-259834 (page 6, paragraph 0071)

### DISCLOSURE OF THE INVENTION

The present invention has achieved based on the above situations, and an object of the present invention is that while the original facial image and plural processed facial images produced via digital processing of the original image are displayed on an image displaying means, the user can more easily select an optimal facial image from among them. Further, another object is to reduce the number of repeated operations to process the facial image.

The above problems can be attained by the means described below.

(1) A facial image processing system to conduct digital image processing on a photographed facial image, including:

a changing means which is at least one of:
a facial expression changing means to change the expression of a facial image;
a skin color tone changing means to change the color tone of facial skin;
an illumination changing means to artificially change the lighting condition on the face; and
a photo angle changing means to artificially change the photographed angle of the face;

an image displaying means to display the facial images; and

an operation means to select the desired changing means and the facial image;

wherein at least one changing means is selected by the operation means, and plural facial images are obtained by conducting image processing, after which the obtained plural facial images are displayed on the image displaying means in the order from a minor facial image change to a major facial image change.

(2) A facial image processing system to conduct digital image processing onto a photographed facial image, including:

a first changing means and a second changing means, both differing from each other and are selected from
a facial expression changing means to change the expression of a facial image;
a skin color tone changing means to change the color tone of facial skin;
an illumination changing means to artificially change the lighting condition on the face; and
a photo angle changing means to artificially change the photographed angle of the face;

an image displaying means to display plural facial images; and

an operation means to select the changing means and the facial image;

wherein the facial image and the first and the second changing means are selected by the operation means, and the plural facial images are produced by conducting digital image processing, after which the plural facial images produced by the first changing means are vertically aligned on the image displaying means in the order from minor facial image change to major facial image change, while the plural facial images produced by the second changing means are aligned horizontally on the image displaying means in the order from minor facial image change to major facial image change.

(3) The facial image processing system described in (1) or (2), further including:

a transparent touch operating means which is adhered onto an image display surface of the image displaying means; and

a facial image shifting means to shift any facial image among the plural facial images displayed by the image displaying means, by an indicating operation to the transparent touch operating means, so as to be adjacent to a similar facial image.

(4) The facial image processing system described in any one of (1)-(3), further including:

a selecting means to select plural facial images displayed on the image displaying means;

an image forming means to produce a hard copy of the selected facial images via the selecting means;

an information inputting means to input image data of the selected facial images chosen by the selecting means; and

a communication means to transfer the image data of the selected facial images chosen by the selecting means to other systems.

### BRIEF DESCRIPTION OF DRAWINGS

FIG. 1 is a block diagram of a facial image processing system.

FIG. 2 is a flow chart to select the optimal image.

FIG. 3 is an example of an image display means to select the image processing factors.

FIG. 4 is example 1 of displayed facial images after image processing has been conducted.

FIG. 5 is example 2 of displayed facial images after image processing has been conducted.

FIG. 6 is example 3 of displayed facial images after image processing has been conducted.

### BEST MODE FOR CARRYING OUT THE INVENTION

The embodiments will now be detailed, while referring to the drawings.

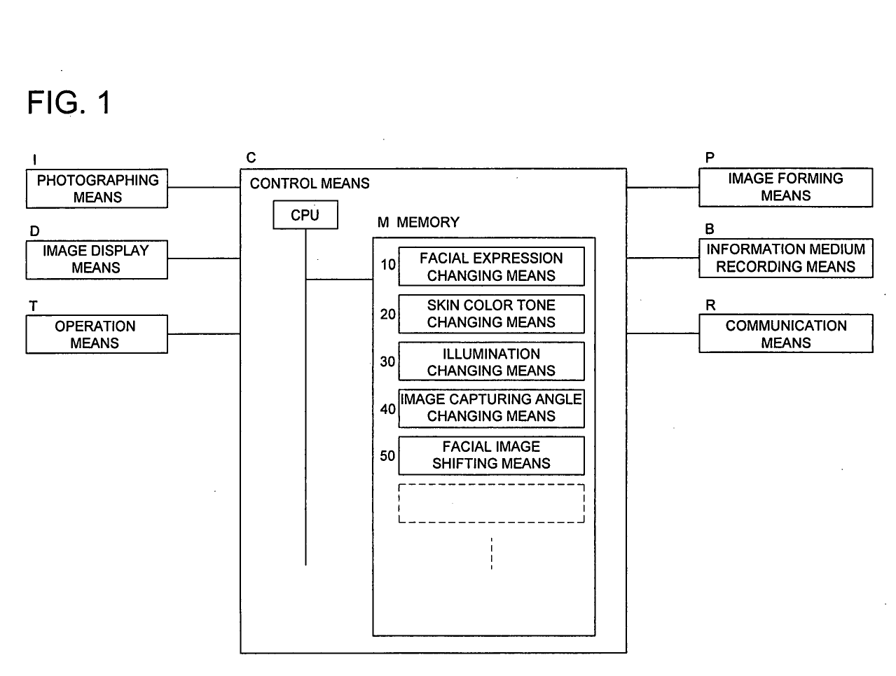

FIG. 1 is a block diagram of a facial image processing system, in which the blocks not relating to the present invention are omitted.

The facial image process system includes control means C functioning as a computer system, photographing means I incorporating a digital camera, image displaying means D to display the images outputted from control means C, operation means T, being a touch panel, including a transparent electrode, adhered onto an image display surface of image displaying means D, image forming means P to output a hard copy of digital image information sent from control means C, information medium recording means B to record image information sent from control means C onto a prescribed recording medium, and communication means R functioning as an interface to send and receive digital image information between control means C and other appropriate information devices.

Control means C functions as a computer system having a CPU, and is structured of a computing unit (which is not illustrated), memory M, and an input-output interface (which is also not illustrated).

Memory M stores various application programs, such as expression changing means 10, skin color tone changing means 20, illumination changing means 30, photo angle changing means 40, and facial image shifting means 50, data files relating to the above programs, and a control program and data files for controlling the system.

Photographing means I, incorporating a digital camera, captures facial digital image information and sends it to control means C. Digital facial image information (which is an original image) is stored in predetermined sections in memory M. Additionally, it is possible for the system to receive an original image from other information devices through communication means R, or from various information recording media, such as a floppy disk (registered trademark), CD, MO, and DVD, through digital information medium recording means B.

Further, as described above, since operating means T, being the touch panel structured of a transparent sheet and a transparent conductive pattern, is adhered onto the image display surface of image displaying means D, on which the user touches predetermined sections of the image on image displaying means D, and thereby, the instructions can be transmitted to control means C.

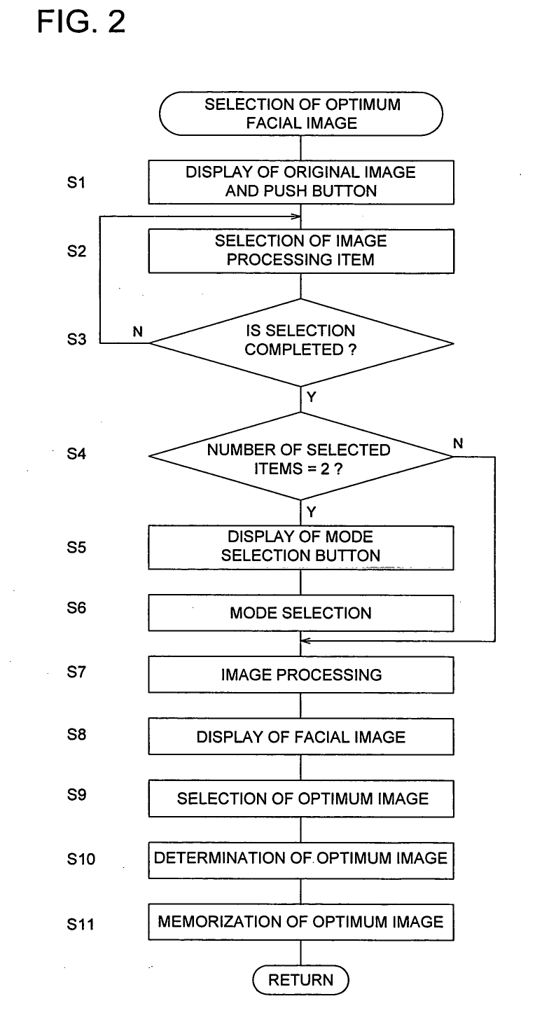

FIG. 2 is a flow chart of the facial image processing system, in which image processing is conducted on the original image, whereby the optimal facial image is selected.

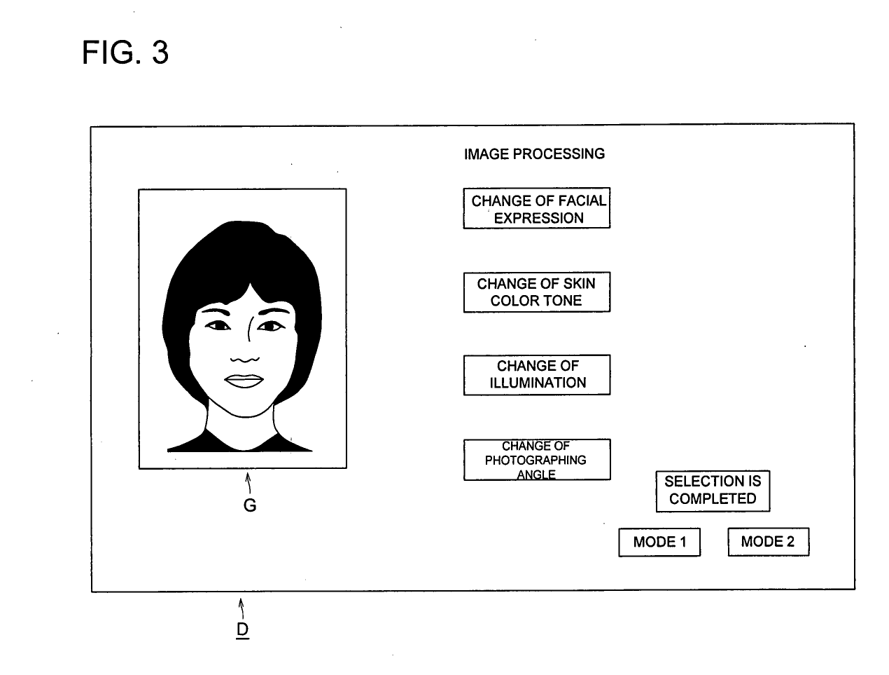

After the program is activated to conduct image processing on the original image, image displaying means D displays original image G (see FIG. 3), and touch switches to select the image changing operations to be conducted on original image G (step S1). Via touching the appropriate touch switch, the user selects the item of the image changing operations to be conducted on the original image (step S2). A single or several items may be selected. After the user touches “selection completed” button on the display, the selection of the item is completed (step S3).

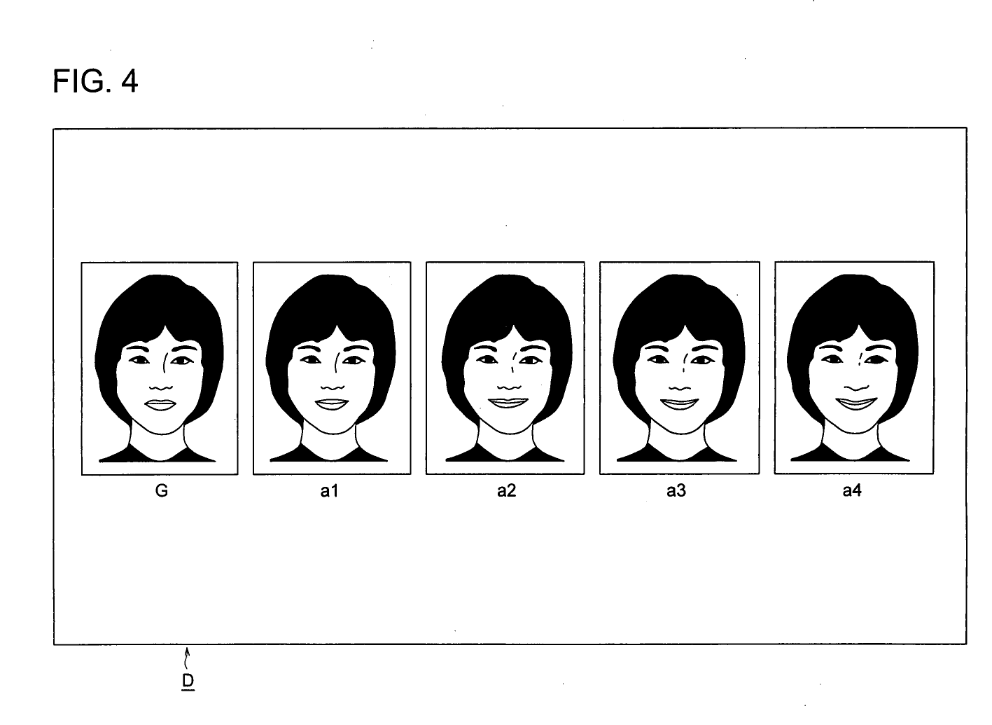

In case that only a single item is selected, the facial image changes are conducted based on-the selected image processing, and are then aligned on the display based on the levels of image processing, that is, aligned based on-the degree of change of the facial images. For example, as shown in FIG. 4, when the specific change of facial expression is selected, the original facial image is arranged on the top left, then other facial images, in which the corners of the mouth are gradually pulled up toward both cheeks from a slight level to a large level, are aligned on image displaying means D.

If facial color tone is selected for change (which is not illustrated), in which skin color tone is gradually changed from a light level to a dark level of a predetermined color tone, the facial images are aligned on image displaying means D.

If a change of the illumination is selected (which is also not illustrated), in which illumination light on the face is gradually changed from the front to the right-or left, the facial images are aligned on image displaying means D.

Further, if a change of photo angle is selected (which is not illustrated), in which photographing position to the face is gradually changed from the front to the right or left, the facial images are aligned on image displaying means D. Additionally, if the number of facial images to be displayed is large, plural rows of facial images are aligned on display means D as necessary.

Further, if two kinds of items (being items 1 and 2) for changing the facial images are selected by the user, two display modes are available. That is, in mode 1, the changes of item 1 are horizontally aligned on the display, which were already conducted with respect to item 1 as described above, after which the changes of item 2 are conducted with respect to item 2, and are aligned under the changes of item 1.

On the other hand, in mode 2, the changes of item 1 are vertically aligned, which were already conducted with respect to mode 1 as described above, after which the vertically aligned facial images are set as the original images, then the changes of item 2 are conducted, and are horizontally aligned from each of item 1.

To select mode 1 or mode 2, the user touches “mode 1” switch or “mode 2” switch on image displaying means D, and touches “selection completed” switch (steps S2, S3, S4, and Yes), and further, touches “mode selection” switch (step S6) to be displayed under “selection completed” switch (step S7).

After the selection of image changing process to be conducted on the original image is completed based on the operation flow described above, the programs for executing the selected image changing process are selected and successively executed, such as facial image changing means 10, skin color tone changing means 20, illumination changing means 30, photo angle changing means 40, and facial image shifting means 50, and thereby all the desired image processes are conducted on the original image.

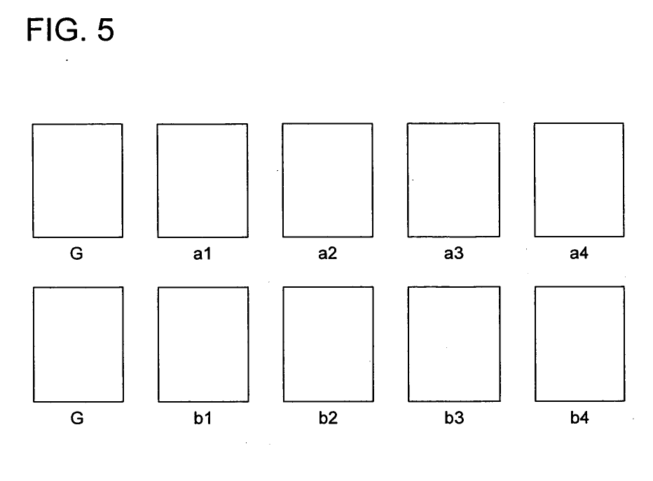

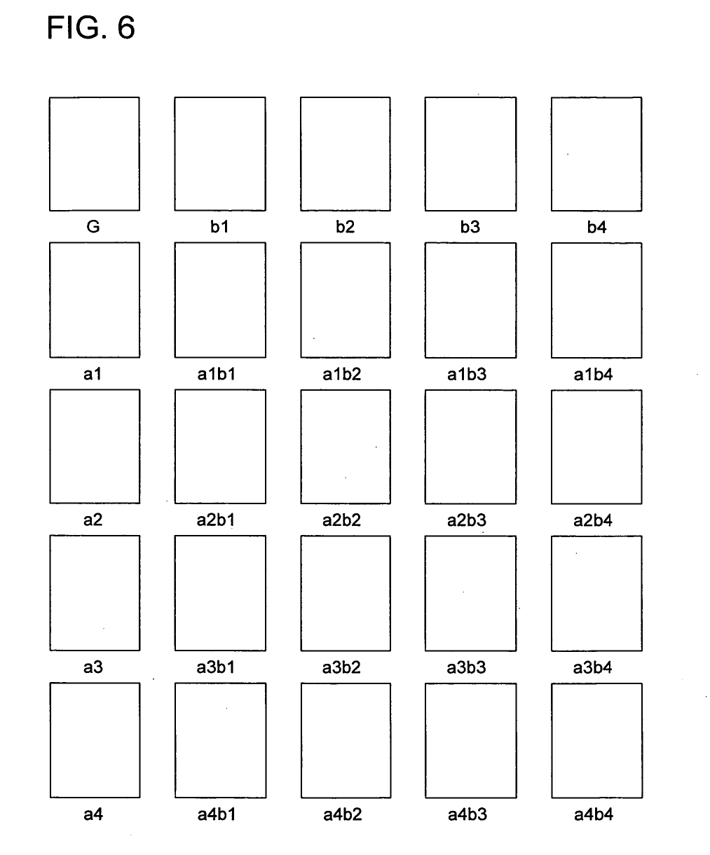

After image processing is completed (step S7), if one image processing was selected (step 8), plural facial images are shown on image displaying means D in FIG. 4 (display example 1). If mode 1 was selected for two image processing, the display shown in FIG. 5 (display example 2) is displayed, while mode 2 was selected, the display shown in FIG. 6 (display example 3) is visible.

In FIGS. 4-6, “a” and “b” show the selected items, while the numerals show the degree of facial image change.

In the explanation of the present example, when two changing means have been selected, one of modes 1 and 2 can be selected. However, when plural changing means greater than or equal to two are selected, two of them are paired, and each of paired changing means is processed by mode 2, and plural results are displayed by the two-dimensional array. For example, if three changing means and mode 2 are selected, the number of two-dimensional arrays of the processed images is three. Further, in some cases, after three changing means are processed, the results can be displayed by a three-dimension array.

Next, the user selects one as the best of the plural facial results, and touches it on the display (step S9), and touches a decision switch shown below in the display to determine the best facial image (step S10). After which, the determined best facial image is stored in a predetermined file (step S11).

The image information stored in the predetermined file can be outputted by image forming means P as a hard copy, or can be stored in various recording media by information medium recording means B, such as floppy disk drive, CD/W, MO drives, and a recording means of DVD/W. Further the stored image can be sent to the other information process devices via communication means R.

In addition, the image information stored in the predetermined file can also be used as an original image for new image process.

If it is difficult for the user to select the best facial image among the displayed plural facial images, it is possible for the user to select some possible facial images and shifts them to be adjacent each other, and compares them in detail to determine the best. This operation is conducted by facial image shifting means 50 which is one of the programs. It is further possible to structure that when the user selects one of the facial images among the plural facial images, and touches it, the touched facial image is enlarged by the system on the display.

In addition, expression changing means 10 is used for changing the facial images by changing the shapes or the angles of eyebrows, eyes, and lip, to change the facial expression. Therefore, the shapes of lip are gradually changed to express the change of smiling degree in the example in FIG. 4.

Yet further, in the above example, the change of smile is used for the change of expression, however, it is possible in the system to break up the change of expression to make determined expression, angry expression, as well as smiling expression, so that any relating areas can be changed, such as eyebrows and tails of eyes. In the same manner as the above, it is also possible in the system to break up the change of skin into color and density, to break up the change of illumination into the number, the position and the angles of illumination, and to break up the change of photo angles into left and right, up and down, and slant, whereby the broken-up sections can be selected.

Yet further, concerning expression changing means 10, skin color tone changing means 20, illumination changing means 30, photo angle changing means 40, and image shifting means 50, all of which are software, can be selected for use among commercially available software, including the software of image process used in the well-known art.

### INDUSTRIAL AVAILABLENESS

Based on the present invention, it is possible to select and execute the image processing means onto the facial image, for the changes of facial expression, skin color tone, illumination, and photo angles, based on the present invention. Further, the various facial images, which are gradually changed by small amounts, are continuously displayed so that the user can easily compare the images and determine the best facial image in a short time.

Yet further, by a single selection and operation of the image processing means, the plural kinds of image process are conducted onto the original image at the same time, and the facial images produced by the image process are shown in the two or three-dimensional displays. Whereby, the user can check the change of the facial images, after the plural kinds of image process were conducted, so that the number of the operation to select the plural image process can be reduced.

Yet further, since any facial images among the plural facial images displayed on the image displaying means, can be arranged adjacent each other, very slight difference between them can be found, which results in the quick selection of the best image. Yet further, the selected best facial image can be outputted as a hard copy, or stored in the recording medium, as well as sent to the other information devices as image information.

1. A facial image processing system for conducting an image process onto a photographed facial image, comprising:
a changing means which is at least one of
a facial expression changing means to change an expression of a photographed facial image;
a skin color tone changing means to change the color tone of facial skin of the photographed facial image;
an illumination changing means to artificially change a lighting condition of the photographed facial image; and
a photo angle changing means to artificially change the photo angle of the photographed facial image;
an image processing means to conduct image processing on the photographed facial image;
an image display means to display photographed facial image and the changed facial images; and
an operation means to select the changing means and the changed facial image;
wherein at least one means among the changing means is selected by the operation means, and the plural changed facial images, obtained via conducting the image processing on the photographed facial image by the selected changing means, are displayed on the image display means in an-order from a small changed facial image to a large changed facial image.

2. A facial image processing system for conducting an image process onto a photographed facial image, comprising:
a first changing section and a second changing section, both differ each other and are selected from
a facial expression changing means to change the expression of a facial image;
a skin color tone changing means to change the color tone of facial skin;
an illumination changing means to artificially change the lighting condition of the face; and
a photo angle changing section to artificially change the photo angle of the face;
an image processing means to conduct image processing on the facial image;
an image display means to display the facial image; and
an operation means to select the changing means and the facial image;
wherein the facial image and the first and the second changing means are selected by the operation means, and the plural changed facial images, obtained via conducting the image processing on the photographed facial image by the first changing means, are vertically displayed on the image display means in the order from a small changed facial image to a large changed facial image, while the plural changed facial images, obtained via conducting the image processing by the second changing means, are horizontally displayed on the image display means in the order from a small changed facial image to a large changed facial image.

3. The facial image processing system in claim 1, further comprising:
a transparent touching operation means which is adhered onto an image display surface of the image display means; and
a facial image shifting means to shift any changed facial image among the plural changed facial images displayed by the image display means, via an indicating operation through the transparent touching operation means, so as to be adjacent to the other changed facial images.

4. The facial image processing system in claim 2, further comprising:
a transparent touching operation means which is adhered onto an image display surface of the image display means; and
a facial image shifting means to shift any changed facial image among the plural changed facial images displayed by the image display means, via an indicating operation through the transparent touching operation means, so as to be adjacent to the other changed facial images.

5. The facial image processing system in claim 1, further comprising:
a selecting means to select a prescribed facial image among the plural changed facial images displayed on the image display device; and
an image forming means to output a hard copy of the prescribed facial image selected by the selecting means.

6. The facial image processing system in claim 1, further comprising:
the selecting means to select a prescribed facial image among the plural changed facial images displayed on the image display means; and
an information inputting means to input image data of the prescribed facial image selected by the selecting means into an information medium.

7. The facial image processing system in claim 1, further comprising:
the selecting means to select a prescribed facial image among the plural changed facial images displayed on the image display device; and
a communication means to transfer the image data of the prescribed facial image selected by the selecting means to other system.

8. The facial image processing system in claim 2, further comprising:
a selecting means to select a prescribed facial image among the plural changed facial images displayed on the image display means; and
an image forming means to output a hard copy of the prescribed facial image selected by the selecting means.

9. The facial image processing system in claim 2, further comprising:
the selecting means to select a prescribed facial image among the plural changed facial images displayed on the image display means; and
an information inputting means to input the image data of the prescribed facial image selected by the selecting means into an information medium.

10. The facial image processing system in claim 2, further comprising:
the selecting means to select a prescribed facial image among the plural changed facial images displayed on the image display means; and
a communication means to transfer the image data of the prescribed facial image selected by the selecting means to other system.

11. The facial image processing system in claim 1, further comprising:
a selecting means to select a prescribed facial image among the plural changed facial images displayed on the image display device; and
a display means which enlarges to display the prescribed facial image selected by the selecting means.
